(19) United States
(12) Patent Application Publication
(10) Pub. No.: US 2024/0021172 A1
(43) Pub. Date: Jan. 18, 2024

(54) LIQUID CRYSTAL DISPLAY DEVICE AND METHOD FOR CONTROLLING LIQUID CRYSTAL DISPLAY DEVICE

(71) Applicant: Sharp Display Technology Corporation, Kameyama City (JP)

(72) Inventor: Masahiro TAKEDA, Kameyama City (JP)

(21) Appl. No.: 18/217,640

(22) Filed: Jul. 3, 2023

(30) Foreign Application Priority Data
Jul. 12, 2022 (JP) 2022-111551

(51) Int. Cl. G09G 3/36; G09G 3/20

(52) U.S. Cl. CPC G09G 3/3685; G09G 3/2096; G09G 2310/0291; G09G 2330/021

(57) ABSTRACT

A liquid crystal display device includes a liquid crystal display panel including a plurality of source bus lines, and a control device connected to the plurality of source bus lines. The control device receives an image signal and drives the plurality of source bus lines at a drive capability corresponding to a refresh rate of the image signal.

### CROSS-REFERENCE TO RELATED APPLICATIONS

This application claims the benefit of priority to Japanese Patent Application Number 2022-111551 filed on Jul. 12, 2022. The entire contents of the above-identified application are hereby incorporated by reference.

### BACKGROUND

### Technical Field

The disclosure relates to a liquid crystal display device and a method for controlling a liquid crystal display device.

Liquid crystal display devices are widely used in portable devices such as notebook computers, tablet terminals, and smartphones. In these portable devices, there is demand for improvements to reduce power consumption and increase battery life.

For example, JP 2003-216118 A discloses a liquid crystal display device capable of suppressing current consumption by using bit information to classify display data, in a source driver, into data of a display pattern with a large amount of white, data of a display pattern with a large amount of black, and data of an intermediate display pattern, and selecting a constant current source having a current capacity suited to the display pattern.

### SUMMARY

In recent years, a technique for dynamically changing a refresh rate has been used as a method for reducing power consumption. It is an object of the disclosure to provide a liquid crystal display device with low power consumption adapted to a variable refresh rate, and a method for controlling the liquid crystal display device.

A liquid crystal display device according to an embodiment of the disclosure includes a liquid crystal display panel including a plurality of source bus lines, and a control device connected to the plurality of source bus lines. The control device receives an image signal and drives the plurality of source bus lines at a drive capability corresponding to a refresh rate of the image signal.

According to the embodiment of the disclosure, a low power consumption liquid crystal display device adapted to a variable refresh rate, and a method for controlling the liquid crystal display device are provided.

### BRIEF DESCRIPTION OF DRAWINGS

The disclosure will be described with reference to the accompanying drawings, wherein like numbers reference like elements.

FIG. 1 is a schematic cross-sectional view illustrating a configuration example of a liquid crystal display device according to an embodiment.

FIG. 2 is a schematic view illustrating a configuration of a TFT substrate.

FIG. 3 is an enlarged schematic view illustrating a pixel of the TFT substrate.

FIG. 4 is a block diagram illustrating a schematic configuration of a control device.

FIG. 5 is a block diagram illustrating a configuration example of a timing controller.

FIG. 6 is a schematic view illustrating a method for measuring a refresh rate.

FIG. 7 is a block diagram illustrating a configuration example of a source driver.

FIG. 8 is a flowchart illustrating an example of a method for controlling the liquid crystal display device.

### DESCRIPTION OF EMBODIMENTS

Embodiments of the disclosure will be described below with reference to the drawings. The disclosure is not limited to the following embodiments, and appropriate design changes can be made within a scope that satisfies the configuration of the disclosure. In the description below, the same reference signs may be used in common among the different drawings for portions having the same or similar functions, and repeated descriptions thereof may be omitted. Further, the configurations described in the embodiments and the modified examples may be combined or modified as appropriate within a range that does not depart from the gist of the disclosure. For ease of explanation, in the drawings referenced below, configurations may be simplified or schematically illustrated, or some components may be omitted. Further, dimensional ratios between components illustrated in the drawings are not necessarily indicative of actual dimensional ratios.

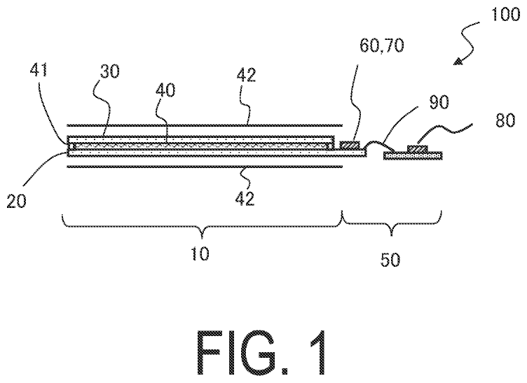

FIG. 1 is a schematic cross-sectional view illustrating a configuration example of a liquid crystal display device 100 according to a present embodiment. The liquid crystal display device 100 includes a liquid crystal display panel 10 and a control device 50. The liquid crystal display panel 10 includes a TFT substrate 20, a counter substrate 30, and a liquid crystal layer 40.

The liquid crystal layer 40 is located between the TFT substrate 20 and the counter substrate 30, and is sealed between the TFT substrate 20 and the counter substrate 30 by a seal 41. The liquid crystal display device 100 may further include a pair of polarizers 42. The pair of polarizers 42 are disposed in a crossed-Nicol manner, sandwiching the liquid crystal display panel 10.

The control device 50 includes a source driver 60, a gate driver 70, and a timing controller 80.

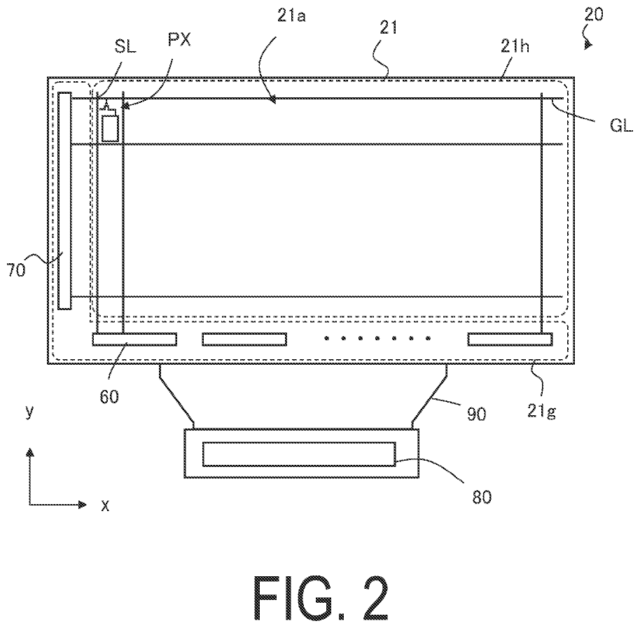

FIG. 2 is a schematic view illustrating a configuration of the TFT substrate 20. The TFT substrate 20 includes a substrate 21, a plurality of source bus lines SL, a plurality of gate bus lines GL, and a plurality of pixels PX.

The substrate 21 has a main surface 21a including a display region 21h and a non-display region 21g that is a region other than the display region 21h. The plurality of gate bus lines GL, the plurality of source bus lines SL, and the plurality of pixels PX are arranged in the display region 21h. Specifically, the plurality of gate bus lines GL extend in an x direction and are arranged at predetermined intervals in a y direction. The plurality of source bus lines SL extend in the y direction and are arranged at predetermined intervals in the x direction. The pixel PX is arranged in a region surrounded by a pair of the gate bus lines GL adjacent to each other and a pair of the source bus lines SL adjacent to each other.

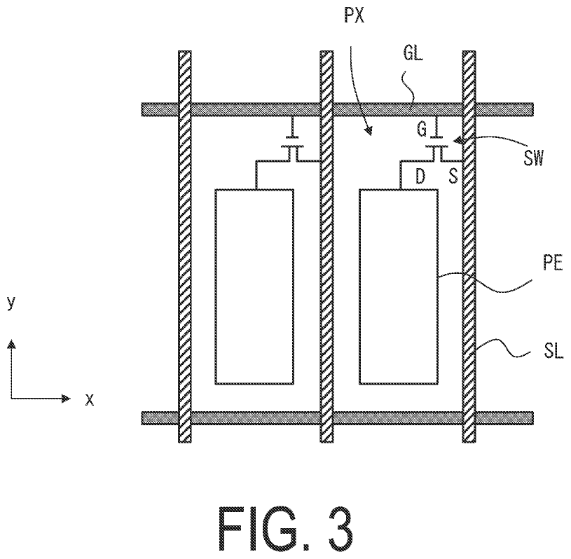

FIG. 3 is an enlarged schematic view illustrating the pixel PX of the TFT substrate 20. Each of the pixels PX includes a pixel electrode PE and a switching element SW. The switching element SW is, for example, a 3-terminal element, and the gate bus line GL, the source bus line SL, and the pixel electrode PE are connected to the three terminals. The switching element is, for example, a TFT and has a gate electrode G connected to the gate bus line GL, a source electrode connected to the source bus line SL, and a drain electrode D connected to the pixel electrode PE.

As illustrated in FIG. 2, the source driver 60 and the gate driver 70 are arranged in the non-display region 21g of the substrate 21. The source bus lines SL and the gate bus lines GL are extended into the non-display region 21g, and, in the non-display region 21g, the source bus lines SL are connected to the source driver 60 and the gate bus lines GL are connected to the gate driver 70. The timing controller 80 and the TFT substrate 20 are connected by a flexible printed circuit (FPC) 90, for example.

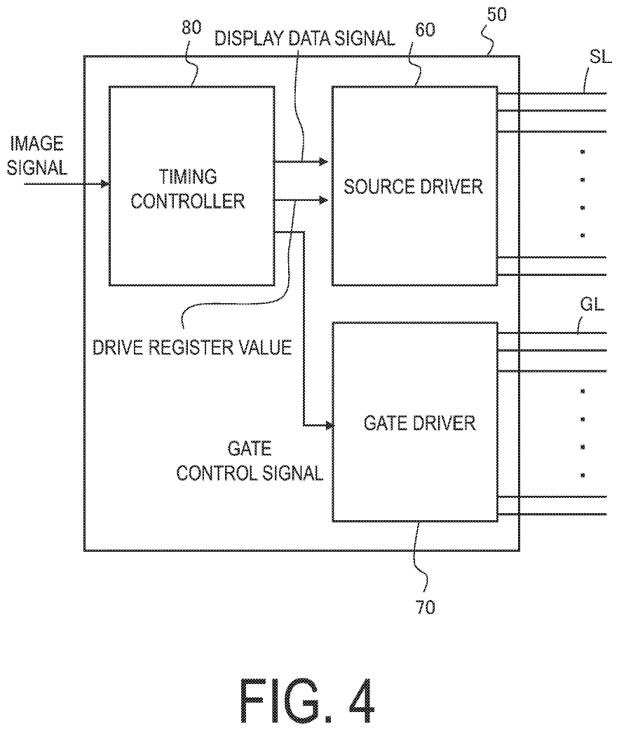

FIG. 4 is a block diagram illustrating a schematic configuration of the control device 50. The control device 50 receives an image signal from a host computer or the like of a device including the liquid crystal display device 100, and drives the gate bus lines GL and the source bus lines SL of the liquid crystal display panel 10. The liquid crystal display device 100 according to the disclosure is adapted to a variable refresh rate, and can display, on the liquid crystal display panel 10, an image signal whose refresh rate is dynamically converted.

For example, when the liquid crystal display device 100 is adapted to refresh rates of 60 Hz and 30 Hz in progressive scanning, when an image is displayed at 30 Hz, the image is rewritten less frequently, and power consumption is smaller than when the image is displayed at 60 Hz. Since the liquid crystal display device 100 supports a variable refresh rate, power consumption at can be reduced when the low refresh rate is low.

Further, the liquid crystal display device 100 according to the disclosure drives the plurality of source bus lines SL at a drive capability corresponding to the refresh rate of the image signal. Specifically, the liquid crystal display device 100 dynamically changes, in accordance with the refresh rate of the image signal, the drive capability of a current source circuit that drives the source bus lines SL.

Therefore, in the control device 50, the timing controller 80 receives the image signal, determines a display data signal and a drive register value corresponding to the refresh rate of the image signal, and outputs the display data signal and the drive register value to the source driver 60. The timing controller 80 also generates a gate control signal from the image signal and outputs the gate control signal to the gate driver 70.

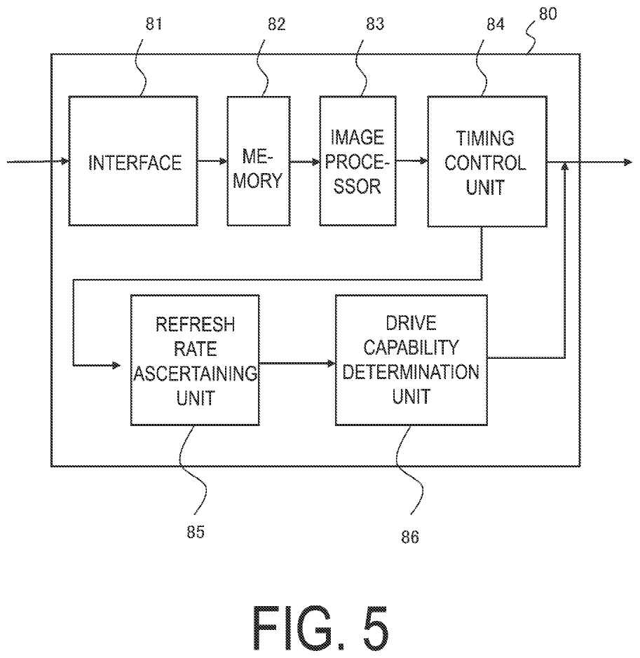

FIG. 5 is a block diagram illustrating a configuration example of the timing controller 80. The timing controller 80 includes, for example, an interface 81, a memory 82, an image processor 83, a timing control unit 84, a refresh rate ascertaining unit 85, and a drive capability determination unit 86. The timing controller 80 as a whole conforms to, for example, the embedded display port (eDP) standard.

The interface 81 receives the image signal, acquires signals such as RGB data of each of the pixels and various clock signals, and outputs the signals to the memory 82. The memory 82 stores the RGB data for panel self-refresh and the like. The image processor 83 performs processing such as color management or gamma correction on the RGB data. The timing control unit 84 generates, from the various clock signals, clock signals for driving the source bus lines SL and the gate bus lines GL. Specifically, the timing control unit 84 generates a source start pulse signal SSP, a source clock signal SCK, a gate start pulse signal GPS, a gate clock signal GCK, and the like.

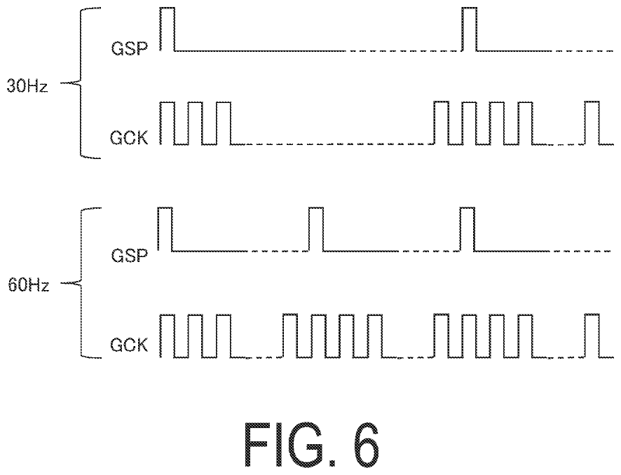

The refresh rate ascertaining unit 85 ascertains the refresh rate of the image signal. For example, the refresh rate ascertaining unit 85 receives the gate start pulse signal GPS and the gate clock signal GCK, and ascertains the refresh rate by counting a number of pulses of the gate clock signal GCK using the gate start pulse signal GPS as a trigger. For example, FIG. 6 illustrates examples of two refresh rates having different intervals between the gate start pulse signals GSP. The example illustrated in the upper part of the drawing is for 30 Hz and the example illustrated in the lower part of the drawing is for 60 Hz.

The drive capability determination unit 86 determines the drive register value corresponding to the ascertained refresh rate. For example, when the refresh rate is 30 Hz, the drive capability determination unit 86 determines “00” as the drive register value, and when the refresh rate is 60 Hz, determines “01” as the drive register value. The determined drive register value is output to the source driver 60 together with the RGB data, the source start pulse signal SSP, and the source clock signal SCK. For example, in accordance with the iSP protocol, after the RGB data, display data including a packet into which the control signal such as the drive register value is inserted is output to the source driver 60.

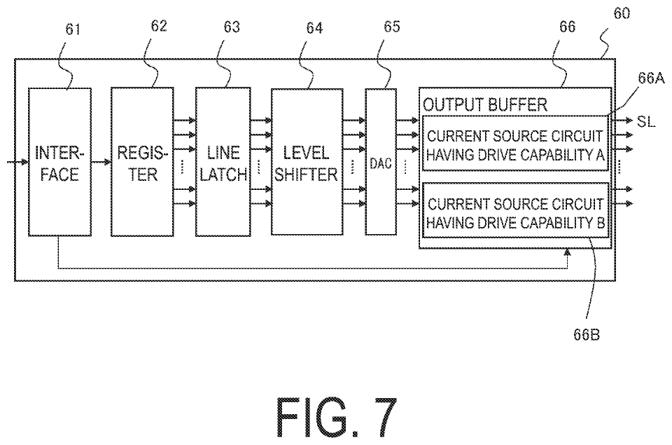

FIG. 7 is a block diagram illustrating a configuration example of the source driver 60. The source driver 60 includes, for example, an interface 61, a register 62, a line latch 63, a level shifter 64, a digital-to-analog converter (DAC) 65, and an output buffer 66.

The interface 61 is compatible with the iSP protocol, and, from the display data received from the timing controller 80, separates the RGB data and the control signal including the drive register value. The register 62 converts the RGB data into data for each of the source bus lines SL. The line latch 63 buffers data for one line, and the level shifter 64 converts an output from the line latch 63. The DAC 65 converts a digital signal into an analog signal.

The output buffer 66 rapidly applies a voltage output from the DAC 65 to the pixels, thus charging the pixel electrodes and auxiliary capacitors. For this charging, the higher the refresh rate, the higher the drive capability of the source bus line, that is, the higher the current supply capability that is required. On the other hand, when the refresh rate is low, a high current supply capability is not required. Therefore, the output buffer 66 includes a plurality of current source circuits having different drive capabilities, so that a plurality of the drive capabilities can be set. For example, the output buffer 66 includes a current source circuit 66A having a drive capability A and a current source circuit 66B having a drive capability B. The drive capability B is larger than the drive capability A, and the current source circuit 66A and the current source circuit 66B are associated with the drive register values.

In accordance with the drive register value, the output buffer 66 selectively uses the corresponding current source circuit 66A or current source circuit 66B to drive the source bus line SL. Specifically, as shown in Table 1 below, the output buffer 66 selects the current source circuit 66A when the drive register value is “00”, and selects the current source circuit 66B when the drive register value is “01”.

TABLE 1

| Refresh rate | Drive register value | Current source circuit |
|---|---|---|
| 30 Hz | 00 | Current source circuit 66A |
| 60 Hz | 01 | Current source circuit 66B |

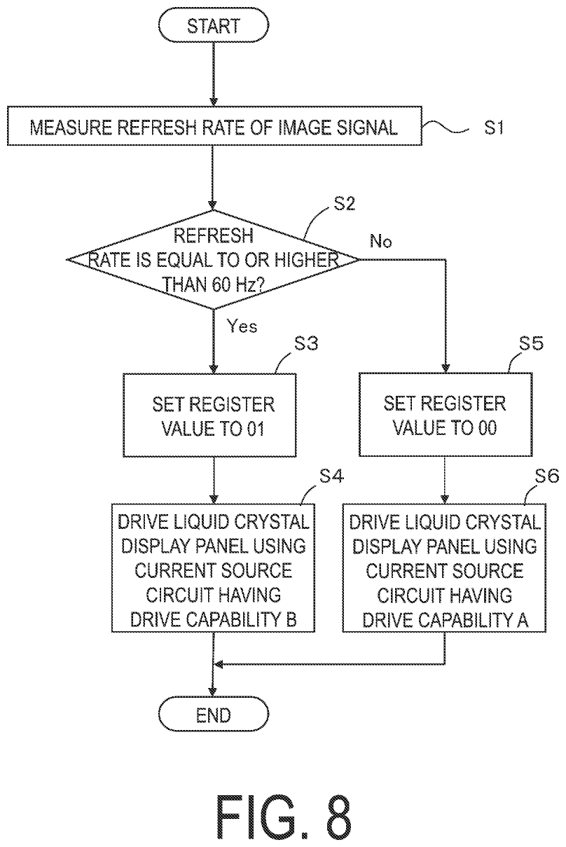

Next, a method for controlling the liquid crystal display device will be described with reference to FIG. 4 to FIG. 7, and to FIG. 8. Since the control device 50 has the above-described configuration, the liquid crystal display device 100 receives the image signal and drives the source bus lines SL and the gate bus lines GL of the liquid crystal display panel 10 to display an image. At this time, since the image signal is compatible with a variable refresh rate, the control device 50 drives the plurality of source bus lines SL using the drive capability corresponding to the refresh rate of the image signal.

FIG. 8 is a flowchart illustrating the method for controlling the liquid crystal display device 100 by the control device 50, when performing operations corresponding to the variable refresh rate.

The control device 50 measures the refresh rate of the received image signal (S1). Specifically, the refresh rate ascertaining unit 85 of the timing controller 80 receives the gate start pulse signal GPS and the gate clock signal GCK from the timing control unit 84, and counts the number of pulses of the gate clock signal GCK using the gate start pulse signal GPS as a trigger.

Subsequently, the refresh rate ascertaining unit 85 ascertains the refresh rate (S2). For example, the refresh rate ascertaining unit 85 ascertains based on whether the refresh rate of the image signal is equal to or higher than 60 Hz. When the measured refresh rate of the image signal is equal to or higher than 60 Hz, in the output buffer 66 of the source driver 60, the current source circuit 66B having the relatively high drive capability is used to drive the source bus lines SL (S3, S4). When the measured refresh rate of the image signal is less than 60 Hz, in the output buffer 66 of the source driver 60, the current source circuit 66A having the relatively low drive capability is used to drive the source bus lines SL (S5, S6). Specifically, the drive capability determination unit 86 determines the drive register value corresponding to the ascertained refresh rate. For example, when the refresh rate is equal to or higher than 60 Hz, the drive capability determination unit 86 determines “01” as the drive register value (S3), and when the refresh rate is lower than 60 Hz, determines “00” as the drive register value (S5). The determined drive register value is output to the source driver 60. The source driver 60 drives the source bus lines SL using the current source circuit corresponding to the received drive register value. Specifically, when the drive register value is “01”, the current source circuit 66B is used (S4), and when the drive register value is “00”, the current source circuit 66A is used to drive the source bus lines SL (S6).

The procedure from S1 to S6 may be executed, for example, every time the refresh rate of the image signal changes. In this case, the control device 50 can detect a change in the refresh rate in the image signal, in response to a dynamic change in the refresh rate of the image signal, and can automatically select the current source circuit to be used, without depending on external control.

As described above, according to the liquid crystal display device and the method for controlling the liquid crystal display device according to the present embodiment, because the liquid crystal display device is adapted to a variable refresh rate, the image is rewritten less frequently when the refresh rate is low, and thereby power consumption is reduced. Furthermore, the drive capability of the output buffer for driving the source bus lines can also be lowered at the time of rewriting. Therefore, the power consumption of the liquid crystal display device at the time of the low refresh rate can be further reduced. Further, such control is performed not by an external host computer or the like, but by the control device of the liquid crystal display device. Therefore, the liquid crystal display device according to the present embodiment can also reduce power consumption when incorporated in various devices.

Further, the source driver in which the output buffer includes the plurality of current source circuits having different drive capabilities, as illustrated in FIG. 7, is available as a general-purpose source driver that can be mounted on liquid crystal panels having various sizes and structures (with or without a touch panel). In the known art, in such a source driver, the drive capability is determined in accordance with the liquid crystal panel on which the source driver is to be mounted. Therefore, once the source driver is mounted on the liquid crystal panel, the plurality of power supply circuits are not selectively used during the operation of the liquid crystal panel. On the other hand, with the liquid crystal display device according to the present embodiment, by using such a general-purpose source driver and selectively using the plurality of power supply circuits during the operation of the liquid crystal panel, power consumption can be reduced as described above with a relatively simple configuration.

The liquid crystal display device disclosed in JP 2003-216118 A is different from the liquid crystal display device according to the present embodiment in that there is no correlation with the refresh rate, and in that a dedicated source driver is required. Further, for example, JP 2012-63753 A discloses a technique for reducing the power consumption of a liquid crystal display device by causing a common voltage applied to a counter electrode to be different for moving image display and for still image display. However, for this purpose, it is necessary to provide a dedicated circuit including a plurality of current source circuits. Further, the common voltage applied to the counter electrode is constant for as long as the moving image display continues. In these points also, the liquid crystal display device according to the present embodiment is different from the liquid crystal display device disclosed in JP 2012-63753 A.

Various modifications can be made to the liquid crystal display device and the method for controlling the liquid crystal display device according to the present embodiment. For example, in the above-described embodiment, the refresh rate of the image signal changes at the two frequencies. However, the refresh rate may be changed at three or more frequencies. For example, the refresh rate of the image signal may be changed at 120 Hz, 60 Hz, and 30 Hz.

In this case, the number of the current source circuits having different drive capabilities provided in the output buffer 66 may be two or three. When the number of the current source circuits is two, for example, the current source circuit 66A may be used when the refresh rate is 30 Hz, and the current source circuit 66B may be used when the refresh rate is 120 Hz or 60 Hz.

When the number of the current source circuits is three, for example, the output buffer 66 may further include a current source circuit 66C having a drive capability C larger than the drive capability B. In this case, the current source circuit 66C corresponds to the refresh rate of 120 Hz. When the refresh rate ascertaining unit 85 ascertains that the refresh rate of the image signal is 120 Hz, the drive capability determination unit 86 outputs a drive register value of “10”, and when the drive register value is “10”, the source driver 60 can drive the source bus lines SL using the current source circuit 66C.

Further, the refresh rate of the image signal may continuously change. In this case, for example, the drive capability determination unit 86 may determine the drive register value based on whether the refresh rate is equal to or higher than a predetermined threshold value (e.g., 60 Hz).

Further, the structure and driving method of the liquid crystal display panel 10 are not limited, and liquid crystal display panels having various structures and driven by various driving methods can be used in the liquid crystal display device and the method for controlling the liquid crystal display device according to the present embodiment.

A liquid crystal display device and a method for controlling a liquid crystal display device according to the disclosure can be explained as follows.

A liquid crystal display device according to a first configuration includes a liquid crystal display panel including a plurality of source bus lines, and a control device connected to the plurality of source bus lines. The control device receives an image signal and drives the plurality of source bus lines at a drive capability corresponding to a refresh rate of the image signal. According to the first configuration, since the drive capability of the source bus line can be varied in accordance with the refresh rate, the power consumption of the liquid crystal display device can be reduced.

In a liquid crystal display device according to a second configuration, with respect to the first configuration, the control device is configured to set a plurality of the drive capabilities, and the lower the refresh rate of the image signal, the lower the drive capability to be set. According to the second configuration, at the time of a low refresh rate, a frequency of rewriting the image becomes lower, and, as well as being able to reduce the power consumption, a power consumption of the output buffer at the time of rewriting can be reduced. Thus, the power consumption of the liquid crystal display device can be further reduced.

In the liquid crystal display device according to a third configuration, with respect to the first configuration, the control device may include a timing controller and a source driver. The timing controller may be configured to receive the image signal, convert the image signal into display data, and determine a drive register value corresponding to the refresh rate of the image signal. The source driver may include an output buffer including a plurality of current source circuits, each of the current source circuits being associated with a drive register value of a plurality of the drive register values, and having a different drive capability. The output buffer may output a signal for driving the plurality of source bus lines, based on the display data, using, of the plurality of current source circuits, a current source circuit associated with the determined drive register value. According to the third configuration, the drive capability of the source bus line can be varied in accordance with the refresh rate without depending on external control.

In the liquid crystal display device according to a fourth configuration, with respect to the first configuration, the timing controller may generate a gate clock signal and a gate start pulse signal from the image signal, ascertain the refresh rate from the gate clock signal and the gate start pulse signal, and determine the drive register value based on an ascertainment result.

A method for controlling a liquid crystal display device according to a fifth configuration is a method for controlling a liquid crystal display device provided with a liquid crystal display panel including a plurality of source bus lines and a control device connected to the plurality of source bus lines. The method includes, by the control device, receiving an image signal and driving the plurality of source bus lines at a drive capability corresponding to a refresh rate of the image signal. According to the fifth configuration, since the drive capability of the source bus line can be varied in accordance with the refresh rate, the power consumption of the liquid crystal display device can be reduced.

In the method for controlling the liquid crystal display device according to a sixth configuration, with respect to the fifth configuration, the control device may be configured to set a plurality of the drive capabilities, and may drive the source bus lines using a lower drive capability, the lower the refresh rate of the image signal. According to the sixth configuration, at the time of the low refresh rate, the frequency of rewriting the image becomes lower, and, as well as being able to reduce the power consumption, the power consumption of the output buffer at the time of rewriting can be reduced. Thus, the power consumption of the liquid crystal display device can be further reduced.

In the method for controlling the liquid crystal display device according to a seventh configuration, with respect to the fifth configuration, the control device may include a source driver including an output buffer including a plurality of current source circuits having different driving capabilities, the source driver being connected to the plurality of source bus lines, and may include a timing controller. The timing controller may receive the image signal, convert the image signal into display data, and determine a drive register value corresponding to the refresh rate of the image signal. The output buffer may output a signal for driving the plurality of source bus lines, based on the display data, using, of the plurality of current source circuits, a current source circuit associated with the determined drive register value. According to the seventh configuration, the drive capability of the source bus line can be varied in accordance with the refresh rate without depending on external control.

In the method for controlling the liquid crystal display device according to an eighth configuration, with respect to the fifth configuration, the timing controller may generate a gate clock signal and a gate start pulse signal from the image signal, ascertain the refresh rate from the gate clock signal and the gate start pulse signal, and determine the drive register value based on an ascertainment result.

### INDUSTRIAL APPLICABILITY

The liquid crystal display device and the method for controlling the liquid crystal display device according to the disclosure are favorably used for a liquid crystal display device adapted to a variable refresh rate used in various applications, and to a method for controlling the liquid crystal display device.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal display device comprising:
a liquid crystal display panel including a plurality of source bus lines; and
a control device connected to the plurality of source bus lines, wherein
the control device receives an image signal and drives the plurality of source bus lines at a drive capability corresponding to a refresh rate of the image signal.

2. The liquid crystal display device according to claim 1,
wherein the control device is configured to set a plurality of the drive capabilities, and
the lower the refresh rate of the image signal, the lower the drive capability to be set.

3. The liquid crystal display device according to claim 2,
wherein the control device includes
a timing controller, and
a source driver,
the timing controller is configured to receive the image signal, convert the image signal into display data, and determine a drive register value corresponding to the refresh rate of the image signal,
the source driver includes an output buffer including a plurality of current source circuits, each of the current source circuits being associated with a drive register value of a plurality of the drive register values, and having a different drive capability, and
the output buffer outputs a signal for driving the plurality of source bus lines, based on the display data, using, of the plurality of current source circuits, a current source circuit associated with the determined drive register value.

4. The liquid crystal display device according to claim 3,
wherein the timing controller generates a gate clock signal and a gate start pulse signal from the image signal, ascertains the refresh rate from the gate clock signal and the gate start pulse signal, and determines the drive register value based on an ascertainment result.

5. A method for controlling a liquid crystal display device provided with a liquid crystal display panel including a plurality of source bus lines and a control device connected to the plurality of source bus lines, the method comprising:
by the control device, receiving an image signal and driving the plurality of source bus lines at a drive capability corresponding to a refresh rate of the image signal.

6. The method for controlling the liquid crystal display device according to claim 5,
wherein the control device is configured to set a plurality of the drive capabilities, and drives the plurality of source bus lines using a lower drive capability, the lower the refresh rate of the image signal.

7. The method for controlling the liquid crystal display device according to claim 6,
wherein the control device includes
a source driver including an output buffer including a plurality of current source circuits having different driving capabilities, the source driver being connected to the plurality of source bus lines, and
a timing controller,
the timing controller receives the image signal, converts the image signal into display data, and determines a drive register value corresponding to the refresh rate of the image signal, and
the output buffer outputs a signal for driving the plurality of source bus lines, based on the display data, using, of the plurality of current source circuits, a current source circuit associated with the determined drive register value.

8. The method for controlling the liquid crystal display device according to claim 7,
wherein the timing controller generates a gate clock signal and a gate start pulse signal from the image signal, ascertains the refresh rate from the gate clock signal and the gate start pulse signal, and determines the drive register value based on an ascertainment result.
